(19) United States
(12) Patent Application Publication
(10) Pub. No.: US 2021/0404505 A1
(43) Pub. Date: Dec. 30, 2021

(54) BOLT HOLDING MEMBER, COMBINED BODY OF BOLT AND BOLT HOLDING MEMBER, AND MOUNTING METHOD

(71) Applicant: FUJIKIN INCORPORATED, Osaka (JP)

(72) Inventors: Tsutomu SHINOHARA, Osaka (JP); Tomohiro NAKATA, Osaka (JP); Takahiro MATUSDA, Osaka (JP); Kazunari WATANABE, Osaka (JP); Tomoki NAKADA, Osaka (JP); Yoshiaki WATANABE, Osaka (JP); Tomoko YUHARA, Osaka (JP); Kengo TSUJINO, Osaka (JP); Masanori UEBAYASHI, Osaka (JP)

(21) Appl. No.: 17/363,970

(22) Filed: Jun. 30, 2021

(30) Foreign Application Priority Data
Jun. 30, 2020 (JP) 2020-112329
Jul. 15, 2020 (JP) 2020-121377

(51) Int. Cl. F16B 39/01

(52) U.S. Cl. CPC F16B 39/01

(57) ABSTRACT

A bolt holding member is made of metal and holds a bolt in a fastened member. The bolt holding member includes: a main body portion that has a cylindrical shape; a first engaging piece that extends from the main body portion toward an inside of the main body portion at an incline relative to an axial direction of the main body portion; and a second engaging piece that extends from the main body portion toward an outside of the main body portion at an incline relative to the axial direction of the main body portion.

### CROSS REFERENCE TO RELATED APPLICATION

The present invention claims priority under 35 U.S.C. § 119 to Japanese Patent Application No. 2020-112329, filed Jun. 30, 2020, and Japanese Patent Application No. 2020-121377, filed Jul. 15, 2020, entire content of which is incorporated herein by reference.

### TECHNICAL FIELD

The present disclosure relates to a bolt holding member, a combined body of a bolt and the bolt holding member, and a mounting method.

### BACKGROUND

A holding ring for preventing a bolt fastened to a fastened member from falling out has been proposed in Republished International Patent Publication No. WO 2006/022103. The holding ring of Republished International Patent Publication No. WO 2006/022103 includes a bolt engaging portion and has a substantially cylindrical shape with a lid, and the holding ring is inserted into an attachment hole formed in the opposite side of the fastened member to the side from which the bolt is inserted. Then, by engaging the bolt engaging portion with the screw thread of the bolt, the bolt is prevented from falling out.

### SUMMARY

However, the holding ring of Republished International Patent Publication No. WO 2006/022103 is formed from fluorine rubber or the like. In recent years, due to increases in the fluid temperature of fluids used in semiconductor manufacturing apparatuses, it has not been possible to use this holding ring in cases where a device or the like is heated to or above the heatproof temperature of fluorine rubber. Moreover, as semiconductor manufacturing apparatuses have decreased in size, bolt holes for fastening devices have also become smaller, making it difficult to secure a holding space that is at least as large as the hole into which the bolt is inserted.

Hence, an object of the present disclosure is to provide a bolt holding member that can be used at high temperatures and can hold a bolt in a fastened member, a combined body of a bolt and the bolt holding member, and a mounting method.

A bolt holding member made of metal and holding a bolt in a fastened member according to one embodiment of the present disclosure includes: a main body portion that has a cylindrical shape; a first engaging piece that extends from the main body portion toward an inside of the main body portion at an incline relative to an axial direction of the main body portion; and a second engaging piece that extends from the main body portion toward an outside of the main body portion at an incline relative to the axial direction of the main body portion.

A combined body of a bolt and a bolt holding member according to one embodiment of the present disclosure includes: the bolt including a shank and a head provided on one end of the shank; and the bolt holding member, which is made of metal, including: a main body portion that has a cylindrical shape and into which the shank inserted; a first engaging piece that extends from the main body portion toward an inside of the main body portion at an incline relative to an axial direction of the main body portion and contacts the shank; and a second engaging piece that extends from the main body portion toward an outside of the main body portion at an incline relative to the axial direction of the main body portion.

A bolt holding member formed in a cylindrical shape from a thin metal plate and holds a bolt in a fastened member having a through hole, according to one embodiment of the present disclosure includes: a tapered portion that tapers toward an end portion of the bolt holding member; and a temporary fixing portion that is capable of temporarily fixing the bolt holding member to the fastened member by contacting an inner surface defining the through hole in the fastened member with elastic force. The bolt holding member is formed with a slit that extends from one end portion to another end portion. A tip end portion of the tapered portion is capable of contacting a shank of the bolt with elastic force.

A combined body of a bolt and a bolt holding member, according to one embodiment of the present disclosure includes: the bolt including a shank and a head provided on one end of the shank; and the bolt holding member formed in a cylindrical shape from a thin metal plate and holds the bolt in a fastened member having a through hole, the bolt holding member including: a tapered portion that tapers toward an end portion of the bolt holding member; and a temporary fixing portion that is capable of temporarily fixing the bolt holding member to the fastened member by contacting an inner surface defining the through hole in the fastened member with elastic force. The bolt holding member is formed with a slit that extends from one end portion to another end portion. A tip end portion of the tapered portion contacts the shank of the bolt with elastic force to hold the bolt.

A mounting method according to one embodiment of the present disclosure connects a first fastened member having a through hole to a second fastened member by using a combined body of a bolt and a bolt holding member. The bolt includes a shank and a head provided on one end of the shank. The bolt holding member is formed in a cylindrical shape from a thin metal plate, is formed with a slit that extends from one end portion to another end portion, and includes a tapered portion that tapers toward an end portion of the bolt holding member and a temporary fixing portion. The mounting method includes: inserting the shank of the bolt into the bolt holding member so that a tip end portion of the tapered portion contacts the shank of the bolt with elastic force; temporarily fixing the bolt and the bolt holding member to the first fastened member by inserting the bolt and the bolt holding member into the through hole in the first fastening member so that the temporary fixing portion contacts an inner surface defining the through hole with elastic force; and mounting the first fastened member to the second fastened member by bringing the first fastened member, to which the bolt and the bolt holding member are temporarily fixed, into contact with the second fastened member and rotating the bolt so as to screw the bolt into a screw hole in the second fastened member.

### BRIEF DESCRIPTION OF THE DRAWINGS

In the drawings:

FIG. 1 is a front view of a fluid control apparatus;

FIG. 2A is a side view of an assembly partially forming a flow passage system of the fluid control apparatus;

FIG. 2B is a sectional view taken along an IIB-IIB line in FIG. 2A;

FIG. 3 is a perspective view of a combined body of a bolt and a bolt holding member according to a first embodiment;

FIG. 4A is a perspective view of the bolt holding member of FIG. 3;

FIG. 4B is a top view of the bolt holding member of FIG. 3;

FIG. 4C is a sectional view taken along an IVC-IVC line in FIG. 4B;

FIG. 5 is a front view of the combined body of the bolt and the bolt holding member, the bolt holding member being shown in cross-section;

FIG. 6A is an illustrative view of a method for connecting an opening/closing valve device to joint blocks using the combined body and a view showing a state in which the combined body is inserted into a through hole in a body of the opening/closing valve device;

FIG. 6B is an illustrative view of the method for connecting the opening/closing valve device to the joint blocks using the combined body and a view showing a state in which the opening/closing valve device is connected to the joint blocks;

FIG. 7A is a perspective view of a bolt holding member according to a modification to the first embodiment;

FIG. 7B is a top view of the bolt holding member according to the modification in FIG. 7A;

FIG. 8A is a perspective view of a combined body of a bolt and a bolt holding member according to a modification to the first embodiment;

FIG. 8B is a perspective view of the bolt holding member according to the modification in FIG. 8A;

FIG. 8C is a top view of the bolt holding member according to the modification in FIG. 8A;

FIG. 9 is a is a perspective view of a combined body of a bolt and a bolt holding member according to a second embodiment;

FIG. 10A is a perspective view of the bolt holding member of FIG. 9;

FIG. 10B is a front view of the bolt holding member of FIG. 9;

FIG. 11 is a front view of the combined body of the bolt and the bolt holding member, the bolt holding member being shown in cross-section;

FIG. 12A is an illustrative view of a method for mounting an opening/closing valve device to joint blocks using the combined body and a view showing a state in which the combined body is inserted into the through hole in the body of the opening/closing valve device;

FIG. 12B is an illustrative view of the method for mounting the opening/closing valve device to the joint blocks using the combined body and a view showing a state in which the opening/closing valve device is mounted on the joint blocks;

FIG. 13A is a perspective view of a combined body of a bolt and a bolt holding member according to a modification to the second embodiment;

FIG. 13B is a perspective view of the bolt holding member according to the modification in FIG. 13A;

FIG. 13C is a front view of the combined body of the bolt and the bolt holding member according to the modification in FIG. 13A, the bolt holding member being shown in cross-section;

FIG. 14A is an illustrative view of a method for connecting an opening/closing valve device to joint blocks using the combined body according to the modification in FIG. 13A and a view showing a state in which the combined body is inserted into the through hole in the body of the opening/closing valve device; and

FIG. 14B is an illustrative view of the method for connecting the opening/closing valve device to the joint blocks using the combined body according to the modification in FIG. 13A and a view showing a state in which the opening/closing valve device is connected to the joint blocks.

### DETAILED DESCRIPTION

A bolt holding member and a combined body of a bolt and the bolt holding member according to a first embodiment of the present disclosure will be described below with reference to the figures.

A bolt holding member 10 and a combined body 20 of a bolt 1 and the bolt holding member 10 according to this embodiment are used in a fluid control apparatus 100, for example.

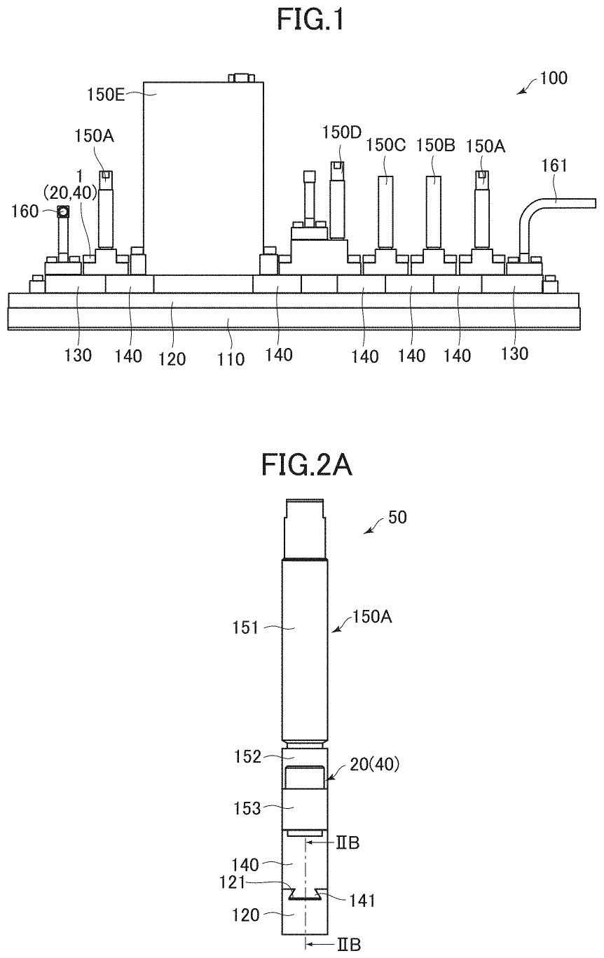

FIG. 1 is a front view of the fluid control apparatus 100.

The fluid control apparatus 100 includes a metal base plate 110, and a plurality of rail members 120 (only one of which is shown in FIG. 1) are provided on the base plate 110. A plurality of joint blocks 130, 140 and various fluid control devices 150A to 150E are arranged on one of the plurality of rail members 120. Fluid passages through which a fluid flows from an upstream side toward a downstream side are formed respectively by the plurality of joint blocks 130, 140.

Here, the “fluid control devices” are devices used in a fluid control apparatus for controlling the flow of a fluid, and each device has a body that defines a fluid flow passage and at least two fluid passage ports that open in a bottom surface of the body. More specifically, each of the “fluid control devices” includes an opening/closing valve device (a two-way valve device) 150A, a regulator 150B, a pressure gauge 150C, an opening/closing valve device (a three-way valve device) 150D, a mass flow controller 150E, and so on, although the “fluid control devices” are not limited to this configuration.

A process gas such as ammonia gas is introduced into the respective flow passage systems of the fluid control apparatus 100 through an introduction pipe 161, for example. The process gas is supplied to a processing chamber, not shown, through a supply pipe 160.

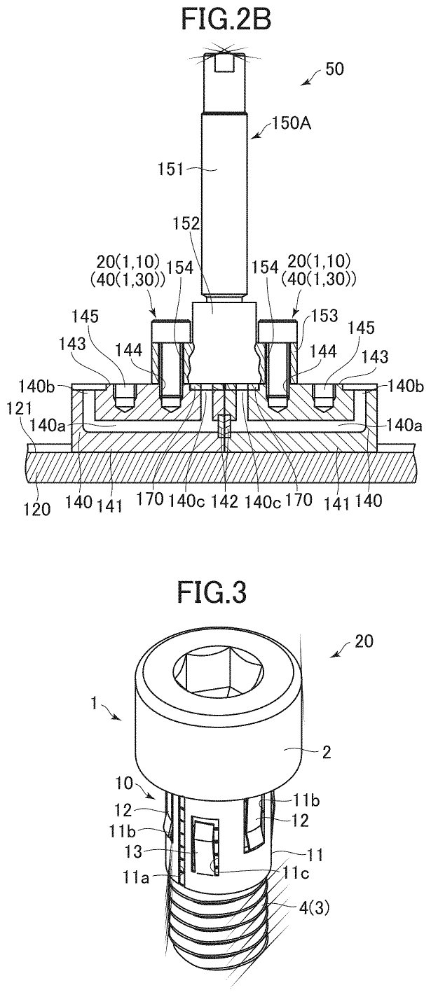

FIG. 2A and FIG. 2B are views showing an assembly 50 partially forming the flow passage system of the fluid control apparatus 100. FIG. 2A is a side view, and FIG. 2B is a partial sectional view taken along an IIB-IIB line in FIG. 2A.

As shown in FIG. 2A and FIG. 2B, the assembly 50 includes a rail member 120, joint blocks 140, 140 disposed on the rail member 120, and an opening/closing valve device 150A disposed on the joint blocks 140, 140 as a fluid control device. Further, gaskets 170, 170 are provided as sealing members between a body 153 of the opening/closing valve device 150A and the joint blocks 140, 140. Furth

Furthermore, the assembly 50 includes the combined body 20 of the bolt 1 and the bolt holding member 10, which is used to connect the body 153 of the opening/closing valve device 150A to the joint blocks 140, 140.

The rail member 120 is an elongated member that is made of a metal such as stainless steel alloy, for example, and has a rectangular cross-section. A groove-shaped guide portion 121 is formed in an upper surface of the rail member 120 so as to extend in a longitudinal direction.

Each joint block 140 is a member that is made of a metal such as stainless steel alloy and has a rectangular parallelepiped shape. A fitting portion 141 is provided in a bottom surface of each joint block 140 so as to extend in the longitudinal direction. The fitting portion 141 is shaped so that the fitting portion 141 can be fitted into the guide portion 121. The joint blocks 140 can be inserted from the respective longitudinal direction end portions of the rail member 120.

A substantially U-shaped fluid flow passage 140a is formed in each joint block 140. Two fluid passage ports 140b, 140c of the fluid flow passage 140a open in an upper surface 143 of each joint block 140. A horizontal part of each fluid flow passage 140a opens in a side face of the corresponding joint block 140. A blocking member 142 is provided on this opening so that the respective openings are blocked.

Two screw holes 144, 145 are formed in each joint block 140 so as to open in the upper surface 143 and extend in the longitudinal direction toward the bottom surface side. The screw holes 144, 145 are positioned between the two flow passage ports 140b, 140c that open in the upper surface 143. The screw holes 144, 145 each have an M5 screw thread with at least three ridges and a depth of approximately 3 mm, for example, although the screw holes 144, 145 are not limited thereto. As regards the dimensional specifications of the joint block 140, for example, the joint block 140 has a width of approximately 10 mm and a length of approximately 30 mm, while the fluid flow passage 140a has a diameter of approximately 2.6 mm and a height of approximately 13 mm, although the joint block 140 is not limited thereto. The joint block 140 and the rail member 120 have substantially matching widths of approximately 10 mm.

The opening/closing valve device 150A includes an actuator portion 151, a valve portion 152, and the body 153, and is supported on the rail member 120 via the joint blocks 140. The width of the body 153 is aligned with the width of the joint block 140 at approximately 10 mm, for example, but is not limited thereto.

The body 153 defines a fluid flow passage, not shown, that communicates with the fluid flow passages 140a in the respective joint blocks 140. A through hole 154 for inserting the combined body 20 (the bolt 1 and the bolt holding member 10) is formed in each of the two longitudinal direction end portions of the body 153. Each through hole 154 has a diameter of approximately 5.5 mm and a clearance of approximately 0.5 mm when only the bolt 1 is inserted therein.

Next, the bolt holding member 10 and the combined body 20 of the bolt 1 and the bolt holding member 10 will be described with reference to the figures.

FIG. 3 is a perspective view of the combined body 20 of the bolt 1 and the bolt holding member 10.

The bolt 1 includes a head 2 and a shank 3, and a screw portion 4 is formed on an outer peripheral portion of the shank 3. The bolt holding member 10 is mounted on the outer periphery of the shank 3 of the bolt 1.

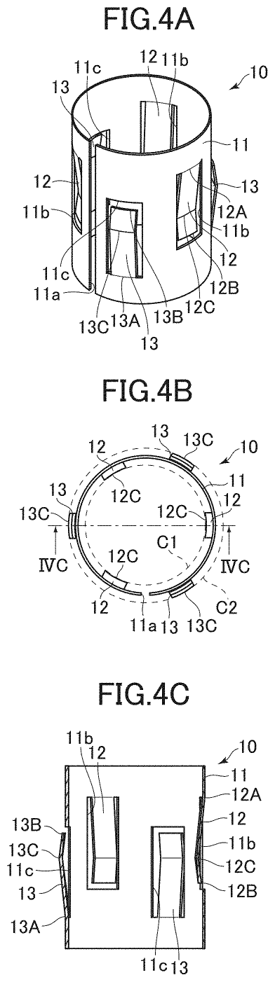

FIGS. 4A to FIG. 4C are views showing the bolt holding member 10. FIG. 4A is a perspective view, FIG. 4B is a top view, and FIG. 4C is a sectional view taken along an IVC-IVC line in FIG. 4B.

The bolt holding member 10 is formed by bending a single thin metal plate (stainless spring steel, for example) into a cylindrical shape, and in order to insert the combined body 20 into the through hole 154, the thin plate has a thickness of approximately 0.1 mm However, the thin plate is not limited thereto as long as requirements relating to strength, springiness, and so on are satisfied. The bolt holding member 10 includes a main body portion 11, a plurality of first engaging pieces 12, and a plurality of second engaging pieces 13.

The main body portion 11 is cylindrical. The two circumferential direction ends of the main body portion 11 are not joined, and therefore a gap 11a is formed to extend in an axial direction from one end to another end. A plurality of (three in this embodiment) U-shaped first slits 11b and a plurality of (three in this embodiment) U-shaped second slits 11c are formed in the main body portion 11 alternately in the circumferential direction. The first slits 11b and the second slits 11c are formed in opposite orientations in a vertical direction. More specifically, in the first slits 11b, the opening of the U shape is positioned on the upper end side in the axial direction of the main body portion 11, whereas in the second slits 11c, the opening of the U shape is positioned on the lower end side in the axial direction of the main body portion 11.

Each first engaging piece 12 has a substantially rectangular shape and extends from the main body portion 11 toward the inside of the main body portion 11 at an incline relative to the axial direction of the main body portion 11. The first engaging pieces 12 are formed by the parts surrounded by the first slits 11b. Each first engaging piece 12 includes a first base end portion 12A that is positioned on the upper end side in the axial direction of the main body portion 11 and connected to the main body portion 11, and a first tip end portion 12B that is positioned further toward the lower end side than the first base end portion 12A in the axial direction of the main body portion 11. The first engaging piece 12 is bent toward the inside of the main body portion 11 from the first base end portion 12A. The first tip end portion 12B is a free end. The first engaging piece 12 extends from the upper end side toward the lower end side of the main body portion 11. The first engaging piece 12 includes a first bent portion 12C that is bent toward the outside of the main body portion 11 between the first base end portion 12A and the first tip end portion 12B.

Each second engaging piece 13 has a substantially rectangular shape and extends from the main body portion 11 toward the outside of the main body portion 11 at an incline relative to the axial direction of the main body portion 11. The second engaging pieces 13 are formed by the parts surrounded by the second slits 11c. Each second engaging piece 13 includes a second base end portion 13A that is positioned on the lower end side in the axial direction of the main body portion 11 and connected to the main body portion 11, and a second tip end portion 13B that is positioned further toward the upper end side than the second base end portion 13A in the axial direction of the main body portion 11. The second engaging piece 13 is bent toward the outside of the main body portion 11 from the second base end portion 13A. The second tip end portion 13B is a free end. The second engaging piece 13 extends from the lower end side toward the upper end side of the main body portion 11. The second engaging piece 13 includes a second bent portion 13C that is bent toward the inside of the main body portion 11 between the second base end portion 13A and the second tip end portion 13B.

The inner diameter of the main body portion 11 is larger than the outer diameter (the screw thread diameter) of the screw portion 4 of the bolt 1, and the outer diameter of the main body portion 11 is smaller than the inner diameter of the through hole 154. As shown in FIG. 4B, the diameter of an imaginary circle C1 formed by the innermost end portions (the first bent portions 12C) of the three first engaging pieces 12 is smaller than the outer diameter (the screw thread diameter) of the screw portion 4 of the bolt 1. The diameter of an imaginary circle C2 formed by the outermost end portions (the second bent portions 13C) of the three second engaging pieces 13 is larger than the inner diameter of the through hole 154.

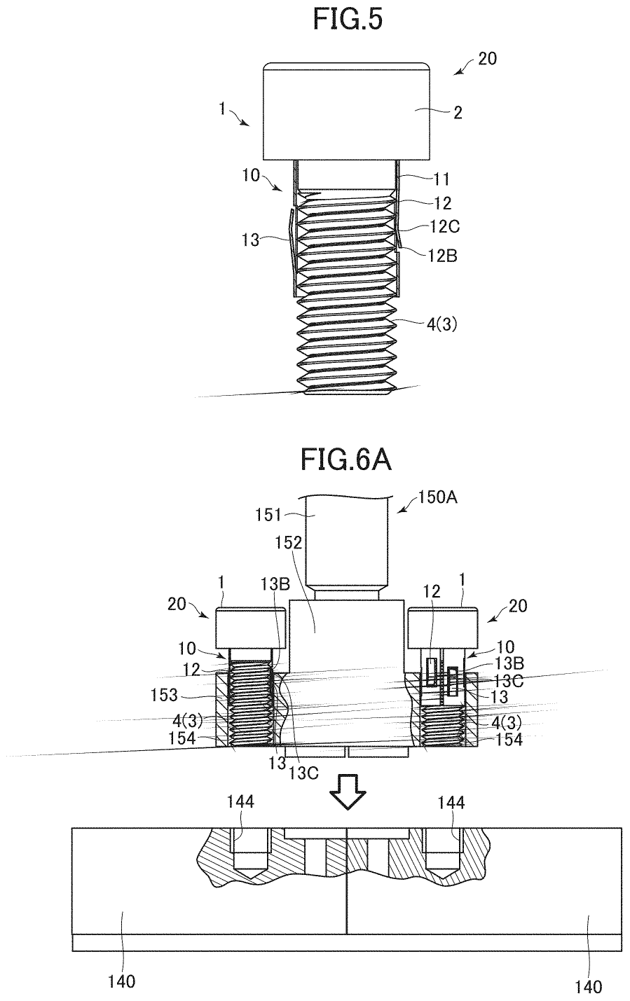

FIG. 5 is a front view of the combined body 20 of the bolt 1 and the bolt holding member 10, the bolt holding member 10 being shown in cross-section.

As shown in FIG. 5, in the combined body 20, the shank 3 of the bolt 1 is inserted into the main body portion 11. In this state, the first engaging pieces 12 contact the shank 3 (the screw portion 4) with elastic force. More specifically, the vicinity of the first bent portion 12C of each first engaging piece 12 contacts the shank 3 (the screw portion 4), while the first tip end portion 12B of the first engaging piece 12 is separated from the shank 3 (the screw portion 4). The first engaging pieces 12 thus function as plate springs.

Next, a method for connecting the opening/closing valve device 150A to the joint blocks 140, 140 using the combined body 20 will be described.

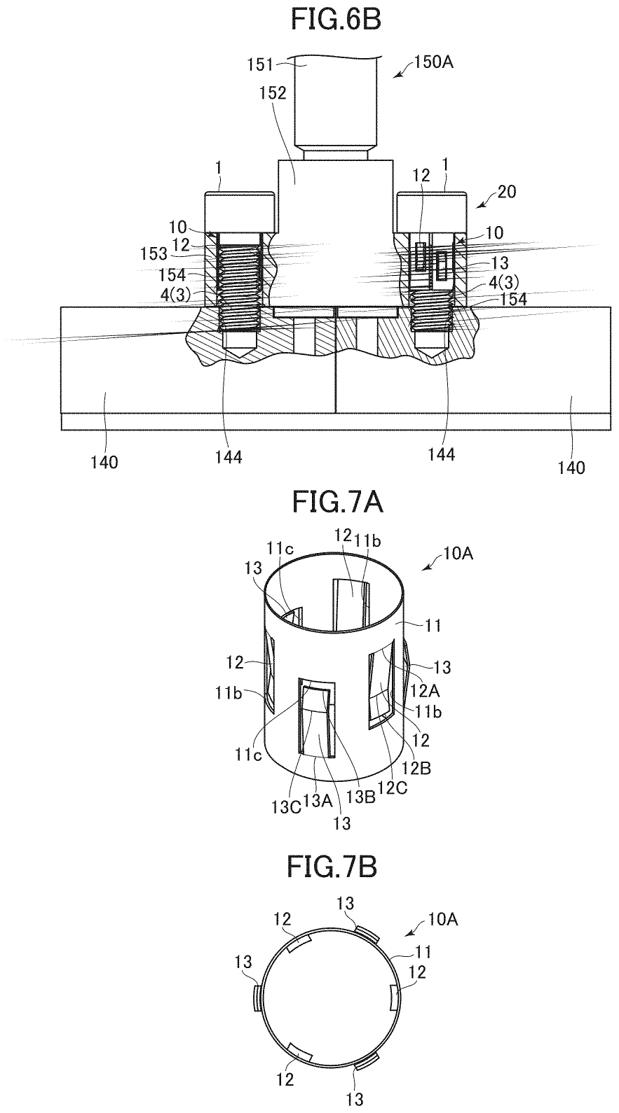

FIG. 6A and FIG. 6B are illustrative views of a method for connecting the opening/closing valve device 150A to the joint blocks 140, 140 using the combined body 20. FIG. 6A is a view showing a state in which the combined body 20 is inserted into the through hole 154 in the body 153 of the opening/closing valve device 150A, and FIG. 6B is a view showing a state in which the opening/closing valve device 150A is connected to the joint blocks 140, 140 by the combined body 20.

As shown in FIG. 6A, the combined body 20 is inserted into each of the through holes 154 in the body 153. In this state, the second engaging pieces 13 contact a surface defining the through hole 154 with elastic force. More specifically, the vicinity of the second bent portion 13C of each second engaging piece 13 contacts the surface defining the through hole 154, while the second tip end portion 13B of the second engaging piece 13 is separated from the surface defining the through hole 154. The second engaging pieces 13 thus function as plate springs.

As shown in FIG. 6B, by bringing the body 153 of the opening/closing valve device 150A, on which the combined bodies 20 are mounted, into contact with the joint blocks 140, 140 and rotating the bolts 1, the screw portions 4 of the bolts 1 are respectively screwed into the screw holes 144. As a result, the opening/closing valve device 150A is connected to the joint blocks 140, 140 by the combined bodies 20.

As described above, the bolt holding member 10 of this embodiment includes the cylindrical main body portion 11, the first engaging pieces 12 that extend from the main body portion 11 toward the inside of the main body portion 11 at an incline relative to the axial direction of the main body portion 11, and the second engaging pieces 13 that extend from the main body portion 11 toward the outside of the main body portion 11 at an incline relative to the axial direction of the main body portion 11. According to this configuration, when the bolt 1 is inserted into the main body portion 11, the first engaging pieces 12 can be brought into contact with the shank 3 of the bolt 1 with elastic force. When the bolt 1 with the bolt holding member 10 mounted thereon is inserted into the through hole 154 in the body 153 of the opening/closing valve device 150A, the second engaging pieces 13 can be brought into contact with the surface defining the through hole 154 with elastic force.

Hence, the bolt 1 can be held in the body 153 of the opening/closing valve device 150A, which serves as a fastened member, enabling an improvement in operability when assembling the assembly 50. Moreover, the bolt holding member 10 is formed from metal and can therefore also be applied to a fluid control device used at high temperatures. Furthermore, by employing the bolt holding member 10, the bolt 1 can be held in the body 153 without the need to secure a large space for holding the bolt 1.

Each first engaging piece 12 includes the first base end portion 12A that is positioned on the upper end side in the axial direction of the main body portion 11 and connected to the main body portion 11, and the first tip end portion 12B that is positioned further toward the lower end side than the first base end portion 12A in the axial direction of the main body portion 11. Each second engaging piece 13 includes the second base end portion 13A that is positioned on the lower end side in the axial direction of the main body portion 11 and connected to the main body portion 11, and the second tip end portion 13B that is positioned further toward the upper end side than the second base end portion 13A in the axial direction of the main body portion 11.

Hence, by inserting the bolt 1 in the extension direction of the first engaging pieces 12 (a direction extending from the first base end portion 12A toward the first tip end portion 12B) from the upper side of the main body portion 11, the first engaging pieces 12 can be prevented from catching on the screw portion 4 of the bolt 1. As a result, the bolt 1 can easily be inserted into the main body portion 11. Further, when the bolt holding member 10 is inserted into the body 153 of the opening/closing valve device 150A, the movement direction of the body 153 relative to the bolt holding member 10 is the same as the extension direction of the second engaging pieces 13 (a direction extending from the second base end portion 13A toward the second tip end portion 13B), and therefore the second engaging pieces 13 can be prevented from catching on the surface defining the through hole 154. As a result, the bolt holding member 10 can easily be inserted into the through hole 154 in the body 153.

The first engaging piece 12 includes the first bent portion 12C that is bent toward the outside of the main body portion 11, and the second engaging piece 13 includes the second bent portion 13C that is bent toward the inside of the main body portion 11. According to this configuration, when it becomes necessary to withdraw the bolt 1 from the bolt holding member 10, the bolt 1 can easily be withdrawn from the bolt holding member 10. Further, when it becomes necessary to withdraw the bolt holding member 10 from the through hole 154 in the body 153, the bolt holding member 10 can easily be withdrawn from the through hole 154 in the body 153.

The main body portion 11 includes the gap 11a that extends in the axial direction from one end to another end, and therefore the diameter of the main body portion 11 can be expanded and contracted. As a result, the bolt 1 can be inserted even more easily into the main body portion 11, and the bolt holding member 10 can be inserted even more easily into the through hole 154 in the body 153.

The U-shaped first slits 11b and second slits 11c are formed in the main body portion 11, the first engaging pieces 12 are formed by the parts surrounded by the first slits 11b, and the second engaging pieces 13 are formed by the parts surrounded by the second slits 11c. Thus, the first engaging pieces 12 and the second engaging pieces 13 can easily be provided in the main body portion 11.

The first engaging pieces 12 and the second engaging pieces 13 are each provided in a plurality and provided alternately in the circumferential direction of the main body portion 11. Thus, the bolt 1 is held relative to the bolt holding member 10 with good balance, and the bolt holding member 10 is held relative to the through hole 154 in the body 153 with good balance.

Furthermore, in the main body portion 11 of the bolt holding member 10 according to this embodiment, the two circumferential direction ends of the main body portion 11 are not joined, and the gap lla is provided to extend in the axial direction from one end to another end. As indicated by a bolt holding member 10A shown in FIG. 7A and FIG. 7B, however, the two circumferential direction ends of the main body portion 11 may be joined so that the main body portion 11 does not have a gap. Apart from not having a gap, the bolt holding member 10A is configured identically to the bolt holding member 10. Likewise with the bolt holding member 10A having this configuration, substantially identical effects to those of the bolt holding member 10 described above can be achieved.

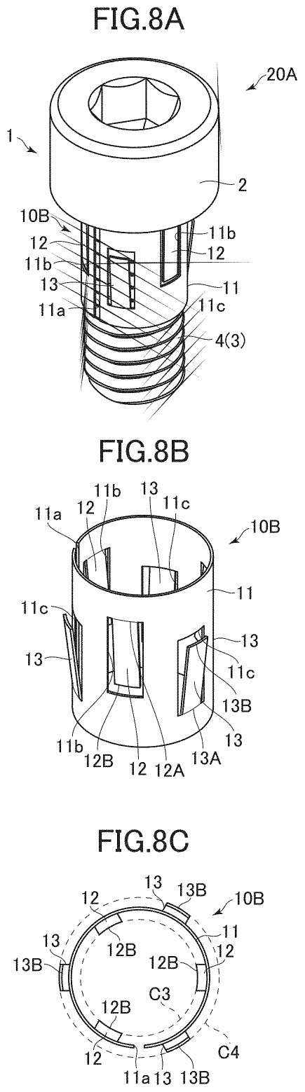

FIG. 8A is a perspective view of a combined body 20A of the bolt 1 and a bolt holding member 10B according to a modification.

FIG. 8B is a perspective view of the bolt holding member 10B according to this modification.

FIG. 8C is a top view of the bolt holding member 10B according to this modification.

As shown in FIGS. 8A to FIG. 8C, the first engaging pieces 12 and second engaging pieces 13 of the bolt holding member 10B do not include a bent portion, and instead, the first engaging pieces 12 extend in a flat shape from the first base end portion 12A to the first tip end portion 12B, while the second engaging pieces 13 extend in a flat shape from the second base end portion 13A to the second tip end portion 13B. As shown in FIG. 8C, the diameter of an imaginary circle C3 formed by the innermost end portions (the first tip end portions 12B) of the three first engaging pieces 12 is smaller than the outer diameter (the screw thread diameter) of the screw portion 4 of the bolt 1. The diameter of an imaginary circle C4 formed by the outermost end portions (the second tip end portions 13B) of the three second engaging pieces 13 is larger than the inner diameter of the through hole 154.

According to this modification, in the combined body 20A, the first engaging pieces 12 contact the shank 3 (the screw portion 4) with elastic force, while the first tip end portions 12B advance further toward a valley side than the ridges of the screw portion 4, and as a result, the bolt 1 can be prevented from falling out of the bolt holding member 10B more reliably.

A method for connecting the opening/closing valve device 150A to the joint blocks 140, 140 using the combined body 20A is similar to the method for connecting the opening/closing valve device 150A to the joint blocks 140, 140 using the combined body 20 of the embodiment described above.

In the embodiment described above, the first engaging pieces 12 and second engaging pieces 13 extend orthogonally to the circumferential direction of the main body portion 11, but the first engaging pieces 12 and second engaging pieces 13 do not have to be orthogonal and may be tilted relative to the circumferential direction.

Next, a bolt holding member, a combined body of a bolt and the bolt holding member, and a mounting method according to a second embodiment of the present disclosure will be described with reference to the figures.

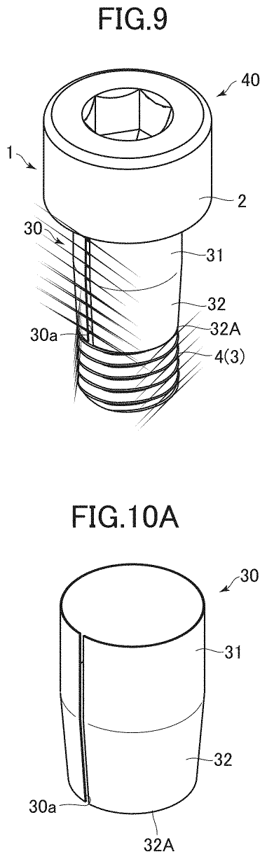

FIG. 9 is a perspective view of a combined body 40 of the bolt 1 and a bolt holding member 30 according to the second embodiment.

The bolt 1 includes the head 2 and the shank 3, and the screw portion 4 is formed on the outer peripheral portion of the shank 3. The bolt holding member 30 is mounted on the outer periphery of the shank 3 of the bolt 1.

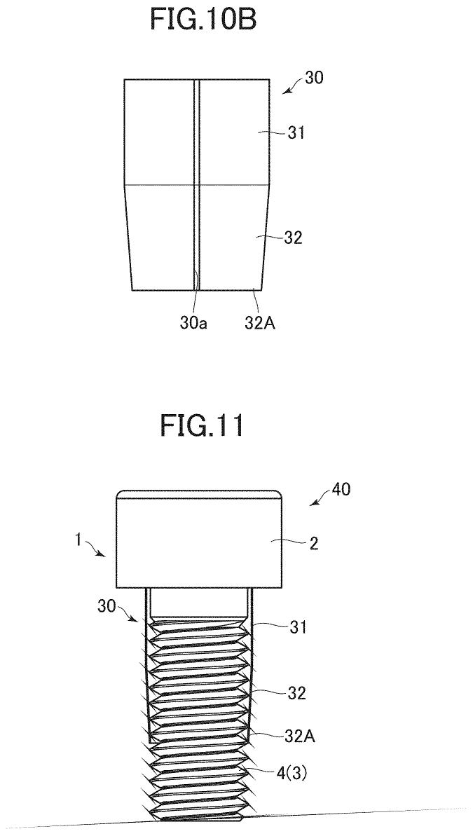

FIG. 10A and FIG. 10B are views showing the bolt holding member 30 of FIG. 9. FIG. 10A is a perspective view, and FIG. 10B is a front view.

The bolt holding member 30 is formed by bending a single thin metal plate (stainless spring steel, for example) into a cylindrical shape, and in order to insert the combined body 40 into the through hole 154, the thin plate has a thickness of approximately 0.1 mm However, the thin plate is not limited thereto as long as requirements relating to strength, springiness, and so on are satisfied.

The bolt holding member 30 includes a straight portion 31 and a tapered portion 32. The two circumferential direction ends of the bolt holding member 30 are not joined, and therefore a slit 30a is formed to extend in the axial direction from one end portion to another end portion.

The straight portion 31 extends in the axial direction and is positioned further toward the head 2 side of the bolt 1 than the tapered portion 32. The tapered portion 32 is connected to the lower end of the straight portion 31 and formed so as to taper toward a tip end portion 32A thereof. A ratio of the axial direction lengths of the straight portion 31 and the tapered portion 32 is set at 1-to-1 in this embodiment, but the ratio is not limited thereto and may be set as appropriate.

The inner diameter of the straight portion 31 is greater than the outer diameter (the screw thread diameter) of the screw portion 4 of the bolt 1, and the outer diameter of the straight portion 31 is smaller than the inner diameter of the through hole 154. The inner diameter of the tip end portion 32A of the tapered portion 32 is smaller than the outer diameter (the screw thread diameter) of the screw portion 4 of the bolt 1.

FIG. 11 is a front view of the combined body 40 of the bolt 1 and the bolt holding member 30, the bolt holding member 30 being shown in cross-section.

As shown in FIG. 11, in the combined body 40, the shank 3 of the bolt 1 is inserted into the bolt holding member 30. In this state, the tip end portion 32A of the tapered portion 32 expands in diameter so as to contact the shank 3 of the bolt 1 with elastic force. As a result, the bolt 1 and the bolt holding member 30 are integrated.

Next, a method for mounting the opening/closing valve device 150A to the joint blocks 140, 140 using the combined body 40 will be described. The opening/closing valve device 150A corresponds to a first fastened member, and the joint blocks 140, 140 correspond to a second fastened member.

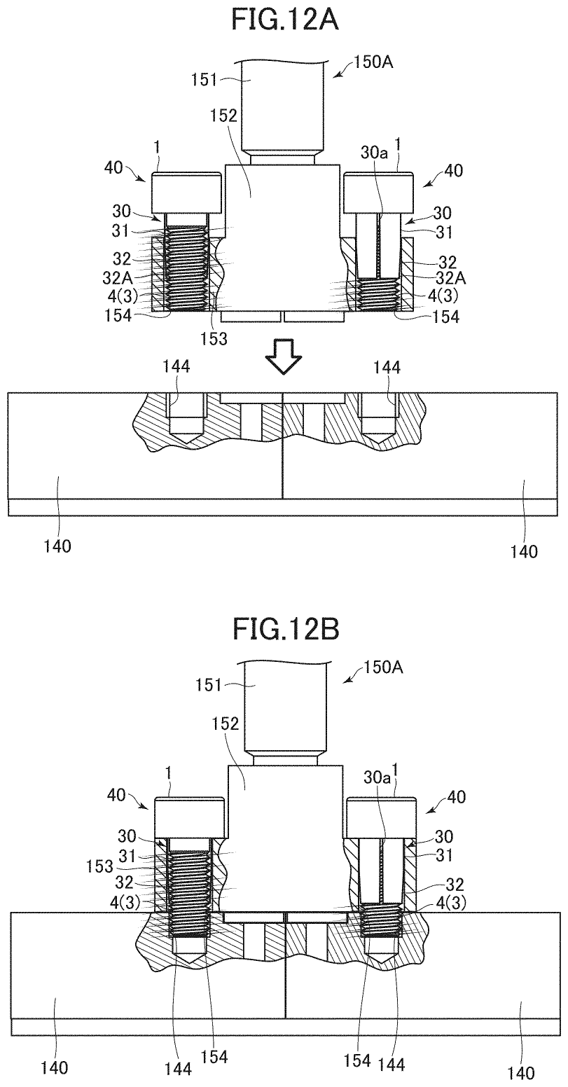

FIG. 12A and FIG. 12B are illustrative views of a method for mounting the opening/closing valve device 150A to the joint blocks 140, 140 using the combined body 40. FIG. 12A is a view showing a state in which the combined body 40 is inserted into the through hole 154 in the body 153 of the opening/closing valve device 150A, and FIG. 12B is a view showing a state in which the opening/closing valve device 150A is mounted on the joint blocks 140, 140 by the combined body 40.

First, as shown in FIG. 11, the shank 3 of the bolt 1 is inserted into the bolt holding member 30 so that the tip end portion 32A of the tapered portion 32 contacts the shank 3 of the bolt 1 with elastic force. As shown in FIG. 12A, the combined body 40 is then inserted into each of the through holes 154 in the body 153 so that a part of the straight portion 31 of the bolt holding member 30 on the tapered portion 32 side contacts the inner surface defining the through hole 154 with elastic force, whereby the bolt holding member 30 is temporarily fixed to the body 153. The part of the straight portion 31 on the tapered portion 32 side functions as a temporary fixing portion. In the bolt holding member 30, the tip end portion 32A of the tapered portion 32 is expanded in diameter by the shank 3, while the straight portion 31 is reduced in diameter by the inner surface defining the through hole 154. As a result, the part of the slit 30a corresponding to the tip end portion 32A of the tapered portion 32 widens, while the part of the slit 30a corresponding to the straight portion 31 narrows.

As shown in FIG. 12B, by bringing the body 153 of the opening/closing valve device 150A, to which the combined bodies 40 are temporarily fixed, into contact with the joint blocks 140, 140 and rotating the bolts 1, the screw portions 4 of the bolts 1 are respectively screwed into the screw holes 144. As a result, the opening/closing valve device 150A is mounted to the joint blocks 140, 140 by the combined bodies 40.

As described above, the bolt holding member 30 according to this embodiment is formed in a cylindrical shape from a thin metal plate and holds the bolt 1 in the opening/closing valve device 150A having the through hole 154. The bolt holding member 30 includes the slit 30a that extends from one end portion to another end portion, the tapered portion 32 that tapers toward the end portion thereof, and the straight portion 31 that is capable of temporarily fixing the bolt holding member 30 to the opening/closing valve device 150A by contacting the inner surface defining the through hole 154 with elastic force, and the tip end portion 32A of the tapered portion 32 is capable of contacting the shank 3 of the bolt 1 with elastic force.

Thus, the bolt 1 can be temporarily fixed to the body 153 of the opening/closing valve device 150A serving as the fastened member, enabling an improvement in operability when assembling the assembly 50. Moreover, the bolt holding member 30 is formed from metal and can therefore also be applied to a fluid control device used at high temperatures. Furthermore, by employing the bolt holding member 30, the bolt 1 can be held in the body 153 without the need to secure a large space for holding the bolt 1.

The bolt holding member 30 includes the straight portion 31 that is connected to the tapered portion 32 so as to extend in the axial direction, and the part of the straight portion 31 on the tapered portion 32 side functions as the temporary fixing portion. By having the straight portion 31 function as the temporary fixing portion in this manner, the bolt 1 and the bolt holding member 30 can be temporarily fixed to the body 153 with stability.

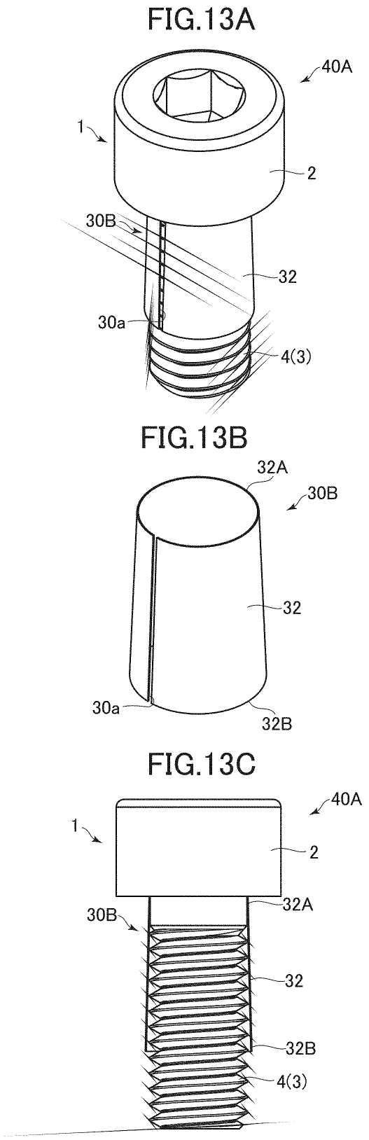

FIG. 13A is a perspective view of a combined body 40A of the bolt 1 and a bolt holding member 30B according to a modification.

FIG. 13B is a perspective view of the bolt holding member 30B according to the modification in FIG. 13A.

FIG. 13C is a front view of the combined body 40A of the bolt 1 and the bolt holding member 30B according to the modification in FIG. 13A, the bolt holding member 30B being shown in cross-section.

As shown in FIGS. 13A to FIG. 13C, in the bolt holding member 30B, the tapered portion 32 forms the entirety of the bolt holding member 30B. In other words, the entirety of the bolt holding member 30B from one end portion to another end portion is constituted by tapered portion 32.

The inner diameter of the tip end portion 32A of the tapered portion 32 is smaller than the outer diameter of the shank 3 of the bolt 1. The inner diameter of a base end portion 32B of the tapered portion 32 is greater than the outer diameter (the screw thread diameter) of the screw portion 4 of the bolt 1, and the outer diameter of the base end portion 32B of the tapered portion 32 is smaller than the inner diameter of the through hole 154.

As shown in FIG. 13C, in the combined body 40A, the shank 3 of the bolt 1 is inserted into the bolt holding member 30B. The tip end portion 32A is positioned further toward the head 2 side of the bolt 1 than the base end portion 32B. In this state, the tip end portion 32A of the tapered portion 32 expands in diameter so as to contact the shank 3 of the bolt 1 with elastic force. As a result, the bolt 1 and the bolt holding member 30B are integrated.

Next, a method for mounting the opening/closing valve device 150A to the joint blocks 140, 140 using the combined body 40A will be described. The opening/closing valve device 150A corresponds to the first fastened member, and the joint blocks 140, 140 correspond to the second fastened member.

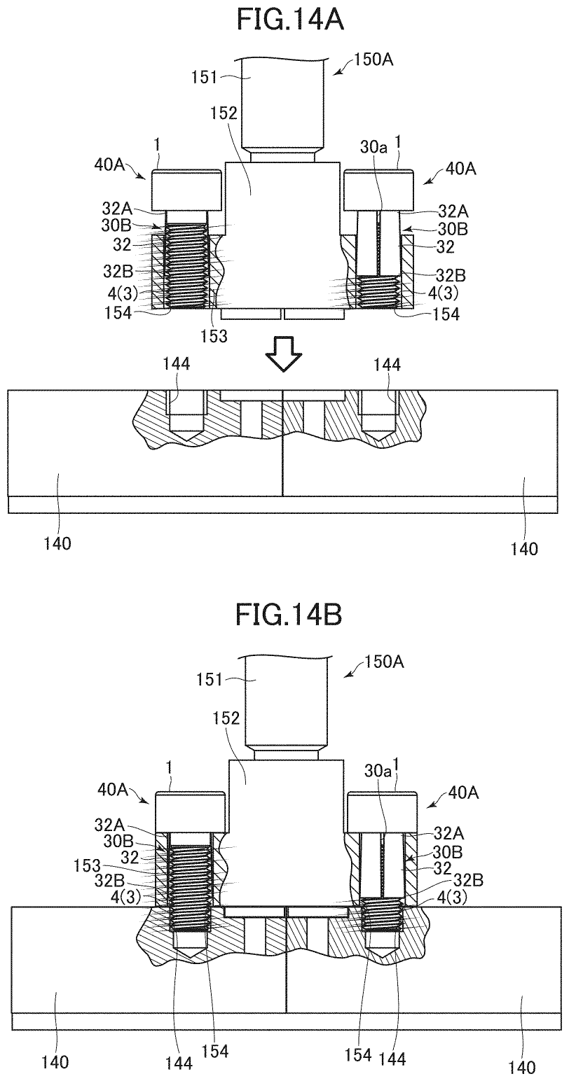

FIG. 14A and FIG.14B are illustrative views of a method for mounting the opening/closing valve device 150A to the joint blocks 140, 140 using the combined body 40A of FIG. 13A. FIG. 14A is a view showing a state in which the combined body 40A is inserted into the through hole 154 in the body 153 of the opening/closing valve device 150A, and FIG. 14B is a view showing a state in which the opening/closing valve device 150A is mounted on the joint blocks 140, 140 by the combined body 40A.

First, as shown in FIG. 13C, the shank 3 of the bolt 1 is inserted into the bolt holding member 30B so that the tip end portion 32A of the tapered portion 32 contacts the shank 3 of the bolt 1 with elastic force. As shown in FIG. 14A, the combined body 40A is then inserted into each of the through holes 154 in the body 153 so that the base end portion 32B of the tapered portion 32 of the bolt holding member 30B contacts the inner surface defining the through hole 154 with elastic force, whereby the bolt holding member 30B is temporarily fixed to the body 153. The base end portion 32B of the tapered portion 32 functions as the temporary fixing portion. In the bolt holding member 30B, the tip end portion 32A of the tapered portion 32 is expanded in diameter by the shank 3, while the base end portion 32B of the tapered portion 32 is reduced in diameter by the inner surface defining the through hole 154. As a result, the part of the slit 30a corresponding to the tip end portion 32A of the tapered portion 32 widens, while the part of the slit 30a corresponding to the base end portion 32B of the tapered portion 32 narrows.

As shown in FIG. 14B, by bringing the body 153 of the opening/closing valve device 150A, to which the combined bodies 40A are temporarily fixed, into contact with the joint blocks 140, 140 and rotating the bolts 1, the screw portions 4 of the bolts 1 are respectively screwed into the screw holes 144. As a result, the opening/closing valve device 150A is mounted on the joint blocks 140, 140 by the combined bodies 40A.

Likewise with the bolt holding member 30B and the combined body 40A of the bolt 1 and the bolt holding member 30B according to this modification, substantially identical effects to those of the bolt holding member 30 and the combined body 40 of the bolt 1 and the bolt holding member 30 according to the embodiment described above can be achieved.

In this embodiment, the part of the straight portion 31 of the bolt holding member 30 on the tapered portion 32 side is caused to function as the temporary fixing portion, but instead, the part of the tapered portion 32 having a larger outer diameter than the inner diameter of the through hole 154 may be caused to function as the temporary fixing portion.

Note that the present disclosure is not limited to the embodiments described above, and persons skilled in the art could implement various additions, modifications, and so on within the scope of the present disclosure.

What is claimed is:

1. A bolt holding member made of metal and holding a bolt in a fastened member, the bolt holding member comprising:
a main body portion that has a cylindrical shape;
a first engaging piece that extends from the main body portion toward an inside of the main body portion at an incline relative to an axial direction of the main body portion; and
a second engaging piece that extends from the main body portion toward an outside of the main body portion at an incline relative to the axial direction of the main body portion.

2. The bolt holding member according to claim 1, wherein
the first engaging piece includes a first base end portion that is positioned on one end side in the axial direction of the main body portion and connected to the main body portion, and a first tip end portion that is positioned further toward another end side than the first base end portion in the axial direction of the main body portion, and
the second engaging piece includes a second base end portion that is positioned on the another end side in the axial direction of the main body portion and connected to the main body portion, and a second tip end portion that is positioned further toward the one end side than the second base end portion in the axial direction of the main body portion.

3. The bolt holding member according to claim 1, wherein
the first engaging piece includes a first bent portion bent toward the outside of the main body portion, and
the second engaging piece includes a second bent portion bent toward the inside of the main body portion.

4. The bolt holding member according to claim 1, wherein the main body portion includes a gap that extends in the axial direction from one end to another end.

5. The bolt holding member according to claim 1, wherein
a first slit has a U-shaped and is formed in the main body portion, and the first engaging piece is formed by a part surrounded by the first slit, and
a second slit has a U-shaped and is formed in the main body portion, and the second engaging piece is formed by a part surrounded by the second slit.

6. The bolt holding member according to claim 1, wherein the first engaging piece and the second engaging piece are each provided in a plurality, and the first engaging pieces and second engaging pieces are provided alternately in a circumferential direction of the main body portion.

7. A combined body of a bolt and a bolt holding member, the combined body comprising:
the bolt including a shank and a head provided on one end of the shank; and
the bolt holding member, which is made of metal, including:
a main body portion that has a cylindrical shape and into which the shank inserted;
a first engaging piece that extends from the main body portion toward an inside of the main body portion at an incline relative to an axial direction of the main body portion and contacts the shank; and
a second engaging piece that extends from the main body portion toward an outside of the main body portion at an incline relative to the axial direction of the main body portion.

8. The combined body of a bolt and a bolt holding member, wherein
the first engaging piece includes a first base end portion that is positioned on one end side in the axial direction of the main body portion and connected to the main body portion, and a first tip end portion that is positioned on another end side in the axial direction of the main body portion,
the second engaging piece includes a second base end portion that is positioned on the another end side in the axial direction of the main body portion and connected to the main body portion, and a second tip end portion that is positioned on the one end side in the axial direction of the main body portion, and
the head of the bolt is positioned on the one end side in the axial direction of the main body portion.

9. A bolt holding member formed in a cylindrical shape from a thin metal plate and holds a bolt in a fastened member having a through hole, the bolt holding member comprising:
a tapered portion that tapers toward an end portion of the bolt holding member; and
a temporary fixing portion that is capable of temporarily fixing the bolt holding member to the fastened member by contacting an inner surface defining the through hole in the fastened member with elastic force,
wherein the bolt holding member is formed with a slit that extends from one end portion to another end portion, and
wherein a tip end portion of the tapered portion is capable of contacting a shank of the bolt with elastic force.

10. The bolt holding member according to claim 9, comprising a straight portion that is connected to the tapered portion and extends in an axial direction,
wherein a part of the straight portion on the tapered portion side functions as the temporary fixing portion.

11. The bolt holding member according to claim 9, wherein the tapered portion forms an entirety of the bolt holding member.

12. A combined body of a bolt and a bolt holding member, the combined body comprising:
the bolt including a shank and a head provided on one end of the shank; and
the bolt holding member formed in a cylindrical shape from a thin metal plate and holds the bolt in a fastened member having a through hole, the bolt holding member including:
a tapered portion that tapers toward an end portion of the bolt holding member; and
a temporary fixing portion that is capable of temporarily fixing the bolt holding member to the fastened member by contacting an inner surface defining the through hole in the fastened member with elastic force,
wherein the bolt holding member is formed with a slit that extends from one end portion to another end portion, and
wherein a tip end portion of the tapered portion contacts the shank of the bolt with elastic force to hold the bolt.

13. The combined body of the bolt and the bolt holding member according to claim 12, wherein the bolt holding member includes a straight portion that is positioned on the head side relative to the tapered portion, is connected to the tapered portion, and extends in an axial direction, and
wherein a part of the straight portion on the tapered portion side functions as the temporary fixing portion.

14. A mounting method for connecting a first fastened member having a through hole to a second fastened member by using a combined body of a bolt and a bolt holding member,
the bolt including a shank and a head provided on one end of the shank,
the bolt holding member that is formed in a cylindrical shape from a thin metal plate, is formed with a slit that extends from one end portion to another end portion, and includes a tapered portion that tapers toward an end portion of the bolt holding member, and a temporary fixing portion,
the mounting method comprising:
inserting the shank of the bolt into the bolt holding member so that a tip end portion of the tapered portion contacts the shank of the bolt with elastic force;
temporarily fixing the bolt and the bolt holding member to the first fastened member by inserting the bolt and the bolt holding member into the through hole in the first fastening member so that the temporary fixing portion contacts an inner surface defining the through hole with elastic force; and
mounting the first fastened member to the second fastened member by bringing the first fastened member, to which the bolt and the bolt holding member are temporarily fixed, into contact with the second fastened member and rotating the bolt so as to screw the bolt into a screw hole in the second fastened member.
